(19) United States
(12) Patent Application Publication
(10) Pub. No.: US 2009/0133061 A1
(43) Pub. Date: May 21, 2009

(54) BROADCASTING PROCESSING APPARATUS AND CONTROL METHOD THEREOF

(75) Inventor: Su-mi KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/202,686

(22) Filed: Sep. 2, 2008

(30) Foreign Application Priority Data
Nov. 20, 2007 (KR) 10-2007-0118796

(51) Int. Cl. H04N 5/445

(52) U.S. Cl. 725/38

(57) ABSTRACT

A broadcasting processing apparatus which receives a broadcasting signal, the broadcasting processing apparatus including a storage unit which stores therein at least one particular broadcasting image, and a controller which determines whether a received broadcasting signal has the broadcasting image if an automatic power-off mode is selected, and turns off power if it is determined that the broadcasting signal has the broadcasting image.

### CROSS-REFERENCE TO RELATED APPLICATION

This application claims priority from Korean Patent Application No. 10-2007-0118796, filed on Nov. 20, 2007, in the Korean Intellectual Property Office, the disclosure of which is incorporated herein by reference.

### BACKGROUND OF THE INVENTION

1. Field of the Invention

Apparatuses and methods consistent with the present invention relate to a broadcasting processing apparatus and a control method thereof, and more particularly, to a broadcasting processing apparatus which receives a broadcasting signal, and a control method thereof.

2. Description of the Related Art

A broadcasting station which transmits a broadcasting signal stops transmitting a broadcasting signal or transmits color bar patterns to adjust a screen if broadcasting time ends.

Typically, a broadcasting signal is not transmitted at night, and a user may limitedly view a broadcasting signal at night. If a user falls asleep or is out while a TV is turned on at night, power consumption continues even through a broadcasting signal is not received.

To address the foregoing problem, a conventional TV has an automatic power-off function to turn off power automatically if a broadcasting signal is not received. However, power is turned off only when there is no signal received. Thus, if color bar patterns are received, power consumption still continues.

### SUMMARY OF THE INVENTION

Accordingly, it is an aspect of the present invention to provide a broadcasting processing apparatus which reduces power consumption, and a control method thereof.

Also, it is another aspect of the present invention to provide a broadcasting processing apparatus which turns off power at a particular time according to a user's preference, and a control method thereof.

Further, it is another aspect of the present invention to provide a broadcasting processing apparatus which displays a user interface (UI) to turn off power at a particular time, and a control method thereof.

Additional aspects and/or advantages of the present invention will be set forth in part in the description which follows and, in part, will be apparent from the description, or may be learned by practice of the present invention.

The foregoing and/or other aspects of the present invention are also achieved by providing a broadcasting processing apparatus which receives a broadcasting signal, the broadcasting processing apparatus comprising: a storage unit which stores therein at least one particular broadcasting image; and a controller which determines whether a received broadcasting signal has the broadcasting image if an automatic power-off mode is selected, and turns off power if it is determined that the broadcasting signal has the broadcasting image.

The broadcasting processing apparatus may further comprise: a user input unit which selects the broadcasting image among received broadcasting signals and stores the broadcasting image; and a UI generator which generates UI information to select and store the broadcasting image.

The broadcasting image may comprise a color bar pattern.

The UI generator may further generate UI information to store channel information of a broadcasting signal having the broadcasting image.

The controller may determine whether channel information of a received broadcasting signal is stored if the automatic power-off mode is selected.

The controller may further determine whether the same broadcasting signals are received for a preset time if a user does not input a control signal for a predetermined time.

The UI generator may further generate UI information to store power-off time information.

The controller may determine whether the received broadcasting signal has the broadcasting image based on stored time information.

The foregoing and/or other aspects of the present invention are also achieved by providing a control method of a broadcasting processing apparatus which receives a broadcasting signal, the control method comprising: storing at least one particular broadcasting image; determining whether an automatic power-off mode is set; determining whether the received broadcasting signal has the broadcasting image if it is determined that the automatic power-off mode is set; and turning off power if it is determined that the broadcasting signal has the broadcasting image.

The broadcasting image may comprise a color bar pattern.

The control method may further comprise storing channel information of a broadcasting signal having the broadcasting image.

The control method may further comprise determining whether same broadcasting signals are received for preset time if a user does not input a control signal for predetermined time.

The control method may further comprise storing power-off time, wherein the determining whether the broadcasting signal has the broadcasting image comprises determining whether the broadcasting signal has the broadcasting image, at a stored time.

### BRIEF DESCRIPTION OF THE DRAWINGS

The above and/or other aspects of the present invention will become apparent and more readily appreciated from the following description of exemplary embodiments, taken in conjunction with the accompanying drawings of which:

FIG. 1 is a control block diagram of a broadcasting processing apparatus according to an exemplary embodiment of the present invention;

FIG. 2 illustrates a particular broadcasting image according to an exemplary embodiment of the present invention;

FIG. 3 illustrates UI information to set an automatic power-off mode according to an exemplary embodiment of the present invention;

FIG. 4 is a control flowchart to describe a control method of the broadcasting processing apparatus according to an exemplary embodiment of the present invention;

FIG. 5 illustrates UI information to set an automatic power-off mode according to another exemplary embodiment of the present invention; and

FIG. 6 is a control flowchart to describe a control method of the broadcasting processing apparatus according to another exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

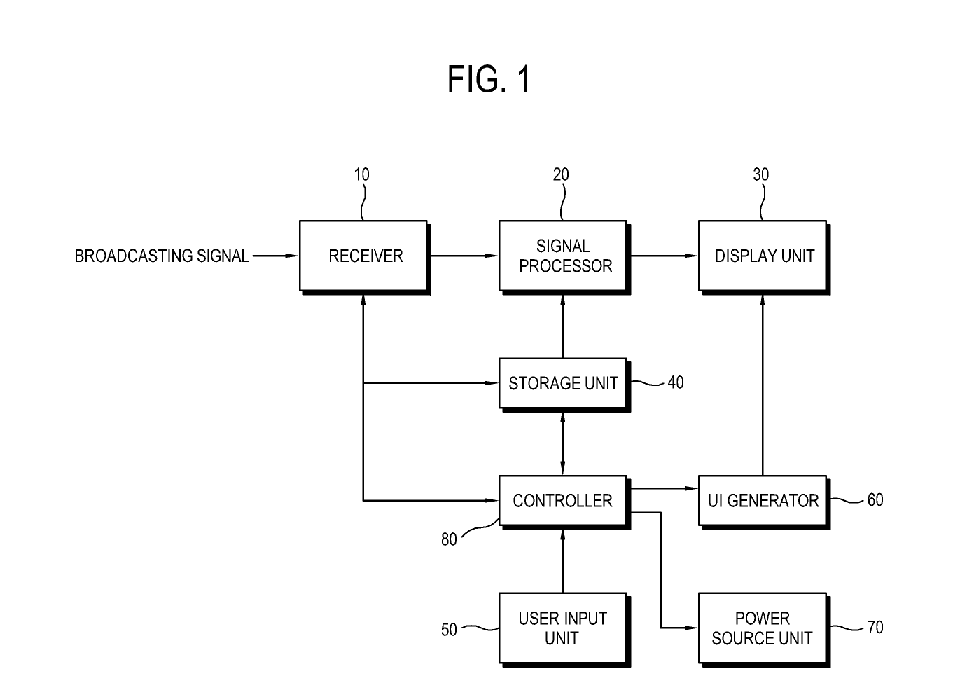

FIG. 1 is a control block diagram of a broadcasting processing apparatus according to an exemplary embodiment of the present invention.

As shown therein, a broadcasting processing apparatus includes a receiver 10, a signal processor 20, a display unit 30, a storage unit 40, a user input unit 50, a UI generator 60, a power source unit 70 and a controller 80 which controls the foregoing elements. The broadcasting processing apparatus may include a set-top box which receives a broadcasting signal from the outside and processes the broadcasting signal or a display apparatus which includes a set-top box. If the broadcasting processing apparatus according to exemplary embodiments of the present invention includes a set-top box, the display unit 30 and the UI generator 60 may be removed.

The receiver 10 receives a broadcasting signal from outside the broadcast processing apparatus. The receiver 10 includes an antenna (not shown), a tuner to tune a broadcasting signal to a particular frequency, i.e., a frequency of a desired channel and a low noise amplifier to amplify a broadcasting signal inputted to the tuner. A broadcasting station which transmits a broadcasting signal transmits not a regular broadcasting signal corresponding to a content but color bar patterns to adjust a screen if regular broadcasting time ends. The broadcasting station mostly transmits color bar patterns from late at night until dawn, e.g., during particular a time such as from 1 am to 5 am. Not all channels receive color bar patterns. If the regular broadcasting time is up, some channels do not receive any signal. Meanwhile, there may be a broadcasting station which transmits a regular broadcasting 24 hours a day.

The signal processor 20 includes an audio processor (not shown) and a video processor (not shown) to separately process a received broadcasting signal into an audio signal and a video signal. The audio processor decodes a received audio signal according to an MPEG standard or Dolby standard, amplifies and outputs it. The video processor decodes video data among inputted broadcasting signals from the receiver 10 according to a predetermined standard, amplifies and outputs it to the display unit 30. The signal processor 20 processes a received broadcasting signal so that the signal is determined whether to have a particular broadcasting image (to be described later), a still image or color bar patterns.

The display unit 30 displays thereon a received broadcasting signal and UI information generated by the UI generator 60. The display unit 30 may include a liquid crystal display (LCD) panel having liquid crystal, an organic light emitting diode (OLED) panel having an organic light emitting element or a plasma display panel (PDP).

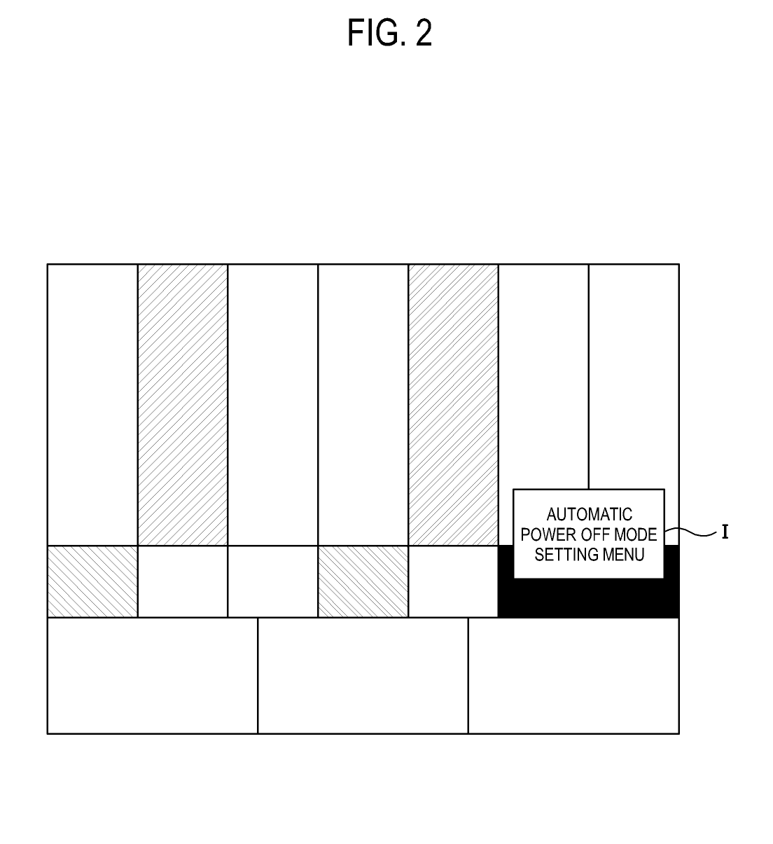

The storage unit 40 stores therein a particular broadcasting image selected by a user and channel information having the broadcasting image, according to a control of the controller 80. The broadcasting image is stored per channel. The particular broadcasting image according to an exemplary embodiment corresponds to color bar patterns transmitted by each broadcasting station. FIG. 2 illustrates color bar patterns. As shown therein, a color bar pattern is generally a still image having a particular pattern. Channels may have different or similar color bar patterns. For example, the color bar patterns may be straight lines or may include a symbol or logo of the broadcasting station, or current time information. An automatic power off mode setting menu window I in FIG. 2 will be described later. The storage unit 40 may include a flash memory embedded in the broadcasting processing apparatus or an external device that is detachable from the broadcasting processing apparatus.

The user input unit 50 is provided to select an automatic power-off mode, generates a selection signal to select and store a particular broadcasting image and outputs various control signals according to a user's manipulation. The automatic power-off mode refers to a mode in which power supplied to the broadcasting processing apparatus is automatically turned off if a certain condition is satisfied. For example, if the receiver 10 does not receive a broadcasting signal, power supplied to the signal processor 20 and the display unit 30 may automatically be turned off The user input unit 50 may include a hot key or a touch panel to select the automatic power-off mode. The user input unit 50 may include a keyboard having a direction key and a setting key or a remote controller to set environment of the automatic power-off mode by using UI information (to be described later).

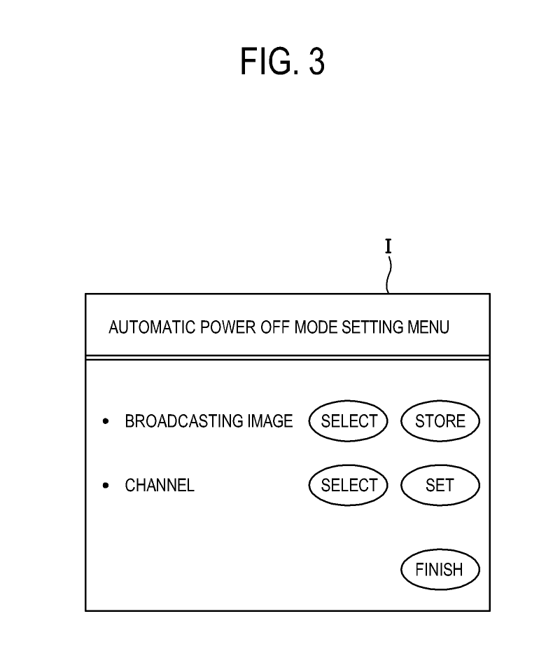

The UI generator 60 generates various UI information to set the environment of the automatic power-off mode and displays the UI information on the display unit 30 according to a control of the controller 80. FIG. 3 illustrates an automatic power off mode setting menu window I according to an exemplary embodiment. If a predetermined control signal is inputted while the display unit 30 displays thereon a broadcasting signal, the UI generator 60 displays the automatic power off mode setting menu window I on the display unit 30. The automatic power off mode setting menu window I includes an item to select and store a broadcasting image and an item to select and set a channel. The automatic power off mode setting menu window I further includes an item “finish” to close itself. If a user selects a broadcasting image, a broadcasting image that is currently displayed on the display unit 30 is selected. If a user selects an item “store”, the selected broadcasting image is stored in the storage unit 40. A channel is also selected and stored in the same method. As described above, the broadcasting image according to an exemplary embodiment includes a color bar pattern. A user may store the color bar pattern per channel. If the same color bar patterns are received from a plurality of channels, a user may select an item “set” and assign two or more channels to the color bar patterns. If a color bar pattern which is received from a particular channel changes, a user may select the color bar patterns again through the automatic power off mode setting menu window I to store them or to change a channel.

If a selection signal is inputted through the user input unit 50 to select the automatic power-off mode, i.e., if the automatic power-off mode is set, the controller 80 determines whether a received broadcasting signal includes a stored broadcasting image, and controls the power source unit 70 to turn off power if it is determined that the broadcasting signal includes the broadcasting image. The power source unit 70 turns off power supplied to the elements of the broadcasting processing apparatus, according to a control of the controller 80.

As described above, a broadcasting station does not transmit a broadcasting signal or transmits a color bar pattern after ending the transmission of a regular broadcasting signal. A conventional broadcasting processing apparatus turns off power if a broadcasting signal is not received and if a power-off signal is not inputted by a user. However, if a broadcasting signal such as color bar patterns is received, the conventional broadcasting processing apparatus continuously receives power while a user falls asleep or is absent. Then, power consumption still continues as the broadcasting processing apparatus is not powered off. Meanwhile, the broadcasting processing apparatus according to exemplary embodiments of the present invention stores a color bar pattern in advance and turns off power automatically to thereby reduce power consumption if a received broadcasting signal includes the color bar pattern. The automatic power-off mode may be set as a default mode during a manufacturing process, and not by a user. In this case, a user may disable the automatic power-off mode through the user input unit 50.

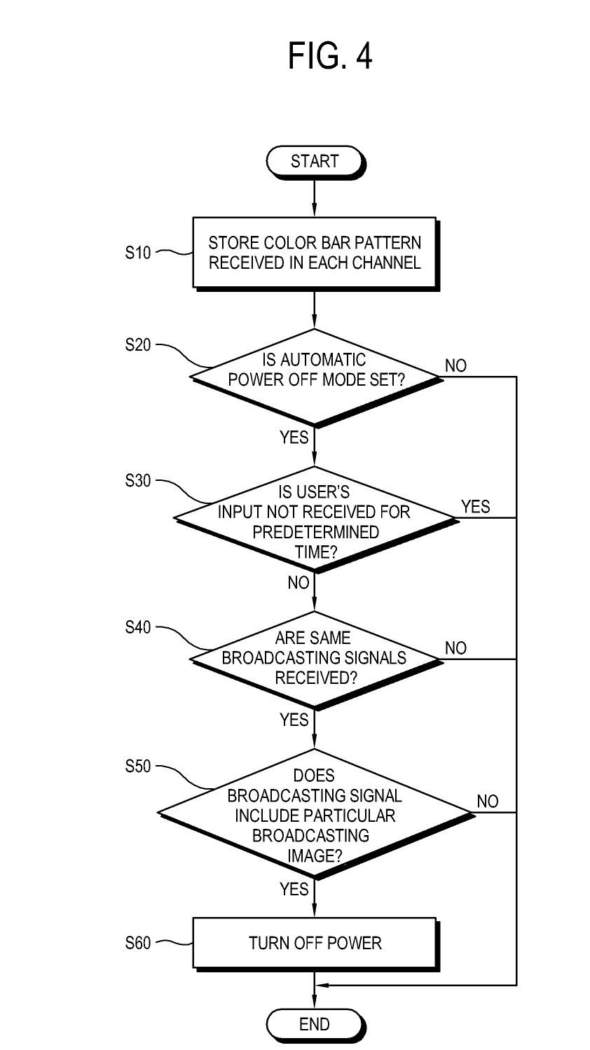

FIG. 4 is a control flowchart to describe a control method of the broadcasting processing apparatus according to an exemplary embodiment. The control method of the broadcasting processing apparatus according to an exemplary embodiment will be described with reference to FIG. 4.

A received color bar pattern is stored by a user for each channel (S10).

The controller 80 determines whether the automatic power-off mode is currently set (S20). The automatic power-off mode is set if a user selects the mode through the user input unit 50. The controller 80 determines whether the automatic power-off mode is set before performing the automatic power-off mode.

A user may store the color bar pattern after setting the automatic power-off mode. There is not a particular order between storing the broadcasting image and setting the automatic power-off mode. The controller 80 performs the automatic power-off mode if the automatic power-off mode is set and the stored broadcasting image exists.

If the automatic power-off mode is set, the controller 80 determines whether a user's input is not received for a predetermined time (S30). That is, the controller 80 determines whether a user's input is received, to turn off power when a user is sleeping or is absent. If a user manipulates the user input unit 50, the automatic power-off mode is not performed.

If a user's input is not received for a predetermined time, the controller 80 determines whether the same broadcasting signals are received (S40). That is, the same broadcasting signal refers to a still image such as a color bar pattern. If the same broadcasting signals are received for a predetermined time, the controller 80 determines that the transmission of the regular broadcasting signal ends.

The controller 80 then determines whether the inputted broadcasting signal includes a particular broadcasting image, i.e., the stored color bar patterns (S50). The controller 80 compares a channel of a received broadcasting signal and a channel stored in the storage unit 40, and then compares the color bar patterns stored corresponding to the same channel as that of the received broadcasting signal, and the received broadcasting signal.

If it is determined that the broadcasting signal includes the color bar patterns, i.e., if the broadcasting signal is the same as the color bar patterns, the controller 80 controls the power source unit 70 to turn off power (S60). If it is determined that the broadcasting signal is not the same as the color bar patterns, power is not turned off

Then, the controller 80 may control the storage unit 40 to additionally store the received color bar patterns.

According to an exemplary embodiment, the color bar patterns may include not a still image but a moving image. In this case, the moving image is stored as the color bar patterns, and the controller 80 may determine whether the same moving images are repeated for a predetermined time.

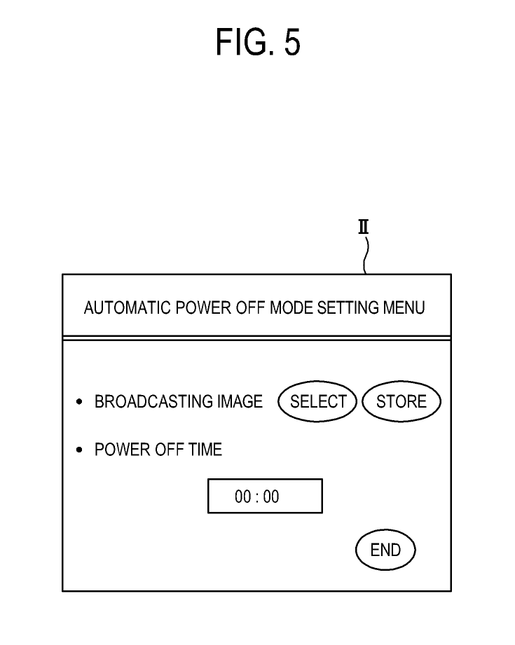

FIG. 5 illustrates UI information to set an environment of an automatic power-off mode according to another exemplary embodiment of the present invention. A broadcasting image according to an exemplary embodiment includes a general broadcasting signal instead of a color bar pattern that is received after regular broadcasting ends. A user may store a broadcasting image of a particular channel received at a particular time. A broadcasting station typically transmits a program's own image before a program starts. The program's own image may include a still image or a moving image. For example, each broadcasting station transmits its own image informing the start of news together with a certain logo song before transmitting the news. In case of a drama, a broadcasting station transmits a prologue image of the drama together with background music before starting transmitting the drama. A user may store the particular time and the images and turn off power by using the stored particular time and image. In this case, an automatic power off mode setting menu window II in FIG. 5 includes an item to set power-off time together with items to select and store a broadcasting image. A user may input power-off time through the user input unit 50. A user may not set a particular time according to his/her preference. As there is no set time, the broadcasting processing apparatus is turned off if the stored image is received from the broadcasting station.

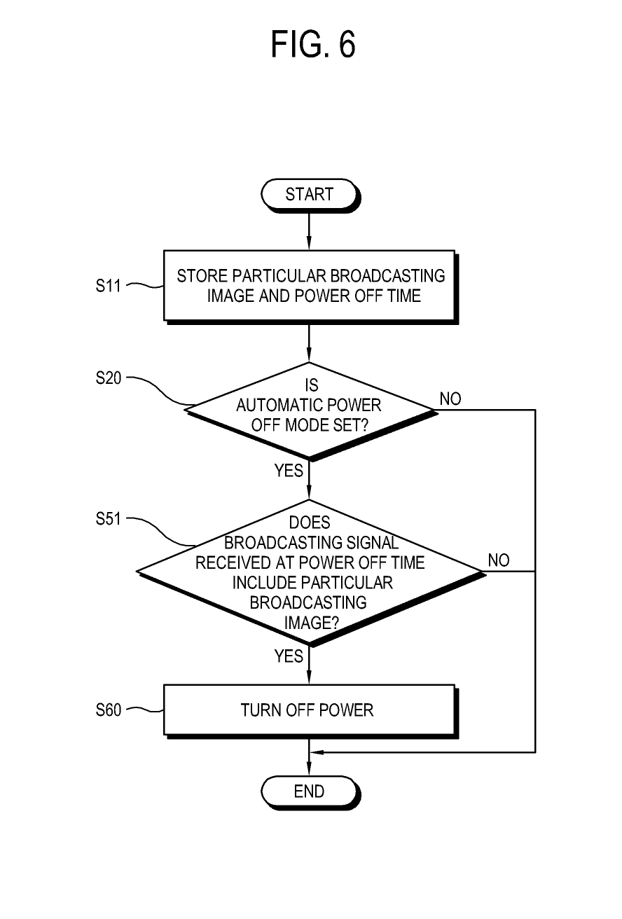

FIG. 6 is a control flowchart to describe a control method of the broadcasting processing apparatus according to an exemplary embodiment. As shown therein, the broadcasting processing apparatus stores the particular broadcasting image and power-off time (S11). Like in a previously described exemplary embodiment as discussed above, the controller 80 according to an exemplary embodiment determines whether the automatic power-off mode is set (S20).

The controller 80 determines whether the broadcasting signal received at the set power-off time includes the particular broadcasting image (S51).

If it is determined that the broadcasting signal includes the stored broadcasting image, power is automatically turned off (S60).

As the broadcasting processing apparatus is turned off if the particular broadcasting signal is received, the broadcasting processing apparatus according to an exemplary embodiment may be used to block a particular program from children. As the broadcasting processing apparatus may store a broadcasting image received in each channel for particular time, it may be used to ban watching TV after a predetermined time.

According to an exemplary embodiment of the present invention, a user may selectively control power of the broadcasting processing apparatus, block a particular broadcasting program or ban watching TV after predetermined time.

As described above, exemplary embodiments of the present invention provide a broadcasting processing apparatus which reduces power consumption, and a control method thereof

Also, exemplary embodiments of the present invention provide a broadcasting processing apparatus which is turned off at particular time according to a user's preference, and a control method thereof.

Further, exemplary embodiments of the present invention provide a broadcasting processing apparatus which displays a user interface to turn off power at a particular time, and a control method thereof.

Although exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcasting processing apparatus which receives a broadcasting signal, the broadcasting processing apparatus comprising:
a storage unit which stores at least one broadcasting image; and
a controller which determines whether the received broadcasting signal has a particular broadcasting image of the at least one broadcasting image if an automatic power-off mode is selected, and turns off power if it is determined that the received broadcasting signal has the particular broadcasting image.

2. The broadcasting processing apparatus according to claim 1, further comprising:
a user input unit which selects the at least one broadcasting image from among received broadcasting signals and stores the at least one broadcasting image; and
a user interface (UI) generator which generates UI information to select and store the at least one broadcasting image.

3. The broadcasting processing apparatus according to claim 2, wherein the at least one broadcasting image comprises a color bar pattern.

4. The broadcasting processing apparatus according to claim 3, wherein the UI generator further generates UI information to store channel information of a particular broadcasting signal having the particular broadcasting image.

5. The broadcasting processing apparatus according to claim 4, wherein the controller further determines whether channel information of the particular broadcasting signal is stored if the automatic power-off mode is selected.

6. The broadcasting processing apparatus according to claim 3, wherein the controller further determines whether same broadcasting signals are received for a preset time if a user does not input a control signal for a predetermined time.

7. The broadcasting processing apparatus according to claim 2, wherein the UI generator further generates UI information to store power-off time information.

8. The broadcasting processing apparatus according to claim 7, wherein the controller further determines whether the received broadcasting signal has the particular broadcasting image based on stored power-off time information.

9. A control method of a broadcasting processing apparatus which receives a broadcasting signal, the control method comprising:
storing at least one broadcasting image;
determining whether an automatic power-off mode is selected;
determining whether the received broadcasting signal has a particular broadcasting image of the at least one broadcasting image if it is determined that the automatic power-off mode is selected; and
turning off power if it is determined that the received broadcasting signal has the particular broadcasting image.

10. The control method according to claim 9, wherein the at least one broadcasting image comprises a color bar pattern.

11. The control method according to claim 10, further comprising storing channel information of a particular broadcasting signal having the particular broadcasting image.

12. The control method according to claim 10, further comprising determining whether same broadcasting signals are received for a preset time if a user does not input a control signal for a predetermined time.

13. The control method according to claim 9, further comprising storing power-off time information, wherein the determining whether the received broadcasting signal has the particular broadcasting image comprises determining whether the received broadcasting signal has the particular broadcasting image, at the stored power-off time.
